(19) United States
(12) Patent Application Publication
(10) Pub. No.: US 2014/0290875 A1
(43) Pub. Date: Oct. 2, 2014

(54) APPARATUS FOR A BLIND

(71) Applicant: Hsueh Tsung Chen, (US)

(72) Inventor: Hsueh Tsung Chen, Taipei (TW)

(73) Assignee: Hsueh Tsung Chen, Taipei (TW)

(21) Appl. No.: 13/854,979

(22) Filed: Apr. 2, 2013

(51) Int. Cl. E06B 9/322; E06B 9/78

(52) U.S. Cl. CPC E06B 9/322; E06B 9/78
USPC 160/149

(57) ABSTRACT

An approach is provided for an apparatus for a blind is disclosed that comprises a rolling module and a control module. The rolling module is located above multiple tapes vertically spaced by a ladder cord. The control module comprises an Epicyclic Gearing (EG) assembly, a tube, a spiral plunger, a universal joint and a control assembly. The tube has a guiding protrusion and a titter. The guiding protrusion is formed inside and bottom of the tube. The titter is configured for controlling the flipping of the tapes. The universal joint is connected between the EG assembly and the tube, and is configured for connecting the rolling module. The control assembly selectively moves up and down on the spiral plunger to rotate the tube. The rolling module raises and/or descends the tapes by the lifting cord according to the rotation of the tube.

### FIELD OF THE INVENTION

Embodiments of the present invention relate to a window blind, and especially toward an apparatus for operating a cordless blind that integrated means of raising, lowering and tilting the tapes into a single component.

### BACKGROUND

Venetian type blinds have a series of slats hung on ladders that extend from a headrail to a bottomrail. In most venetian blinds a lift cord is provided each having one end attached to the bottomrail and then passing through elongated holes in the slats up to and through the headrail. When the lift cords are pulled downward the blind is raised and when the lift cords are released the blind is lowered.

In operation, a user must draw the lift cord as a means to open or close the window blind to a desirable position. However, the small frictional surface of the lift cord tends to rub against the hands exerting force thereon, and thus hurting the area of hands contacting with it. Besides, in case of an excessive down-pulling force exerted onto the lift cord or a sudden release at a great speed, the blind body cannot be accurately positioned in a desirable position and the adjustment process must be repeated over again, which is quite inconvenient in operation and may hurt the user's hand.

In recent years the art has been concerned that cords, particularly looped cords, pose a strangulation threat to children who may become entangled in the cords. Consequently, there has been much interest in cordless blinds. These blinds rely on electric motors or spring motors to raise and lower the lift cord. One common cordless blind simply contains a motor connected to a collection system within the head-rail. Another cordless blind relies upon a constant force spring motor attached to spools on which the lift cords are collected. Such structures of the cordless have at least drawbacks of complexities of its components, high costs and hard to adapt to all sized of the window blind.

Therefore, there is a need to develop a method or a mechanism to improve the operations of a cordless window blind without using electric motors or spring motors to raise and lower the lift cord.

### SOME EXEMPLARY EMBODIMENTS

These and other needs are addressed by the present invention, wherein an approach is provided for an apparatus for operating a cordless window blind.

According to one aspect of an embodiment of the present invention, an apparatus for a blind comprises a rolling module and a control module. The rolling module is located above multiple tapes vertically spaced by a ladder cord, each tape has an eyelet that communicates to other eyelets and allows a lifting cord extended downwardly from the rolling module. The control module is extended downwardly from the rolling module and comprises an Epicyclic Gearing (EG) assembly, a tube, an universal joint, a spiral plunger, a control assembly. The EG assembly is connected to the rolling module. The tube is a hollow column structure and has a guiding protrusion and a tilter. The guiding protrusion is formed inside and bottom of the tube and the tilter is formed outside of the tube corresponded to the guiding protrusion. The universal joint is connected between the EG assembly and the tube, and is configured for connecting the rolling module. The control assembly is penetrated through the spiral plunger, is located at bottom of the spiral plunger, and selectively moves up and down on the spiral plunger to rotate the tube, wherein the rolling module raises or lowers the tapes by the lifting cord according to the rotation of the tube.

According to another aspect of an embodiment of the present invention, the rolling module of the apparatus for blind further comprises a driving shaft, multiple lifting reels and multiple flipping reels. Each lifting reel has a shaft hole and a lifting gearwheel. The shaft hole of the lifting reel is configured for inserting the driving shaft, and one of the lifting reel is connected to the EG assembly with the driving shaft. The flipping reels are engaged to the corresponding lifting reels, and having a top and an opening. The tops of the flipping reels are configured for fixing the corresponding ladder cords. The opening comprises a teethed portion and a smooth portion formed at inner of the opening, which is corresponded to the lifting gearwheels of the lifting reels that is configured for engaging the teethed portion with the lifting gearwheel.

Therefore, the embodiment of the present invention provides a simple operating blind apparatus than a conventional blind.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a perspective view of a blind in accordance with an embodiment of the present invention;

FIGS. 2A to 2C are a views of illustrating a control module (a spiral plunger, an

Epicyclic Gearing assembly, an universal joint, a tube and the control assembly) in accordance with an embodiment of the present invention;

FIGS. 3A and 3B are views of an embodiment of the blind in accordance with the present invention showing that the tube spins anti-clockwise in response to the movement of the actuator;

FIGS. 4A and 4B are views of an embodiment of the blind in accordance with the present invention showing that the tube spins clockwise in response to the movement of the actuator;

FIG. 5 is a diagram illustrating a structure of the rolling module in accordance with an embodiment of the present invention;

FIGS. 6A to 6C are views of an embodiment of the blind in accordance with the present invention showing the movement of the ladder cords in response to the spinning of the tilter; and

FIG. 7 is a diagram illustrating a structure of the Epicyclic Gearing (EG) assembly in accordance with an embodiment of the present invention.

### DESCRIPTION OF THE PREFERRED EMBODIMENT

An apparatus for operating a cordless venetian blind are disclosed. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

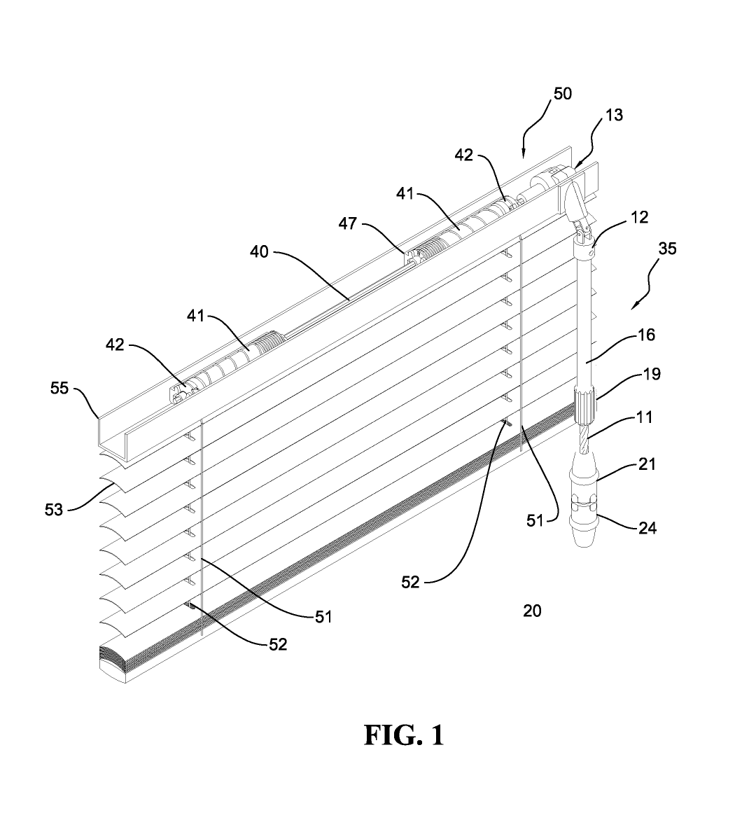

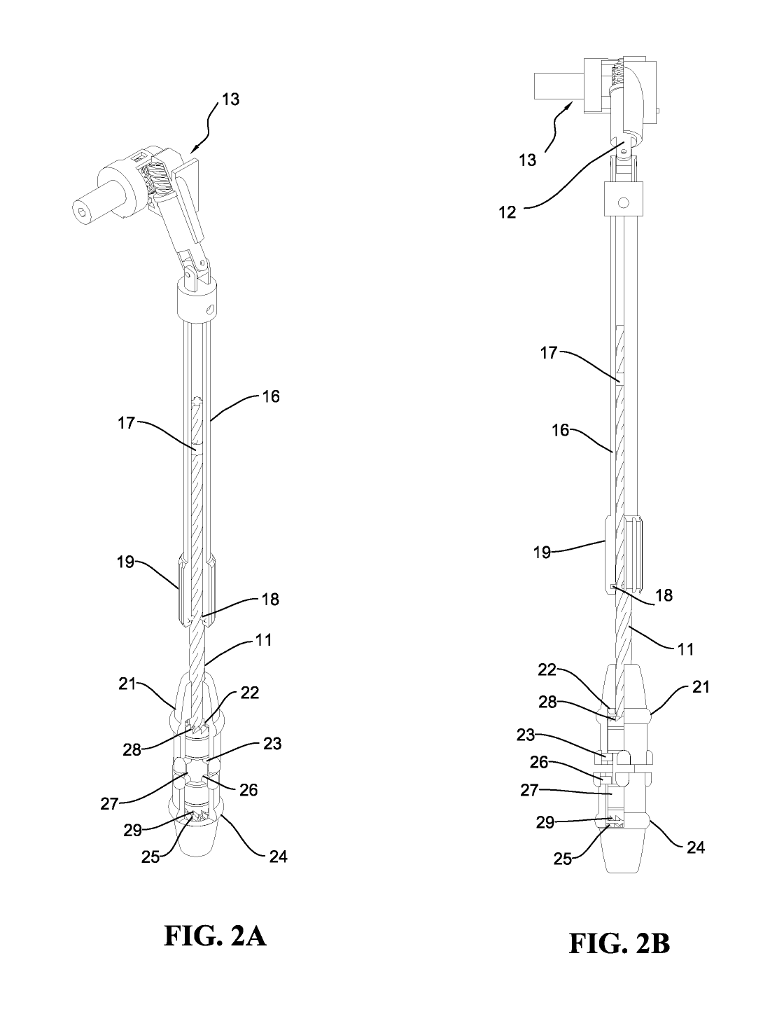

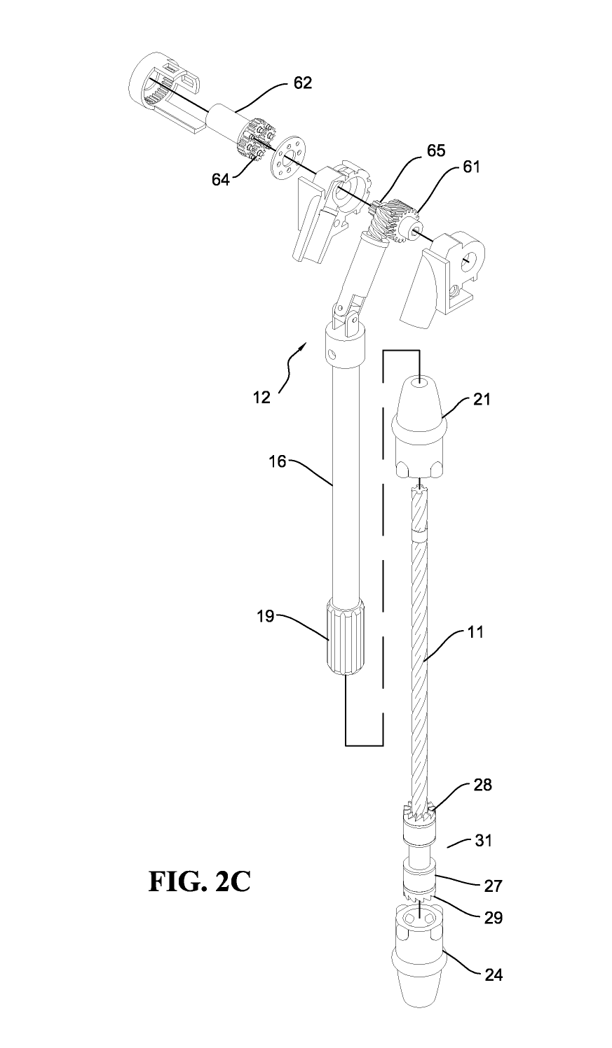

With reference to FIGS. 1, 2A, 2B and 5, a blind apparatus in accordance with an embodiment of the present invention comprises a rolling module 50 and a control module 35. The rolling module 50 is disposed above multiple tapes 53 vertically spaced from ladder cords 51. Each tape 53 has at least one eyelet communicated to other eyelets of the tapes 53 that allow a lifting cord 52 extended downwardly from the rolling module 50. As shown in FIG. 1, when the rolling module 50 is triggered (e.g. rotating), the lifting cord 52 is configured for raising and lowing the tapes 53, and the ladder cords 51 are configured for rotating of the tapes 53.

The control module 35 is extended downwardly from the rolling module 50 and comprises Epicyclic Gearing (EG) assembly 13, a spiral plunger 11, a universal joint 12, a tube 16, a block 17 and a control assembly 20. The EG assembly 13 is connected to the rolling module 50. The tube 16 is a hollow column structure and has a guiding protrusion 18 and a tilter 19. The guiding protrusion 18 is formed inside and bottom of the tube 16. The tilter 19 is formed outside of the tube 16 corresponded to the guiding protrusion 18. The universal joint 12 is connected between the EG assembly 13 and the tube 16, and is configured for connecting the rolling module 50. The spiral plunger 11 is penetrated through the tube 16 from the guiding protrusion 18 and has a spiral interacted with the guiding protrusion 18. The block 17 is mounted at the top of the spiral plunger 11 which is configured for preventing the spiral plunger 11 falls off from the tube 16. The control assembly 20 is penetrated through the spiral plunger 11, is located at bottom of the spiral plunger 11, and selectively moves up and down on the spiral plunger 11 to rotate the tube 16. The rolling module 50 raises and/or lowers the tapes 53 by the lifting cord 52 according to the rotation of the tube 16. The tilter 19 is configured for a person to grip on and rotates the tube 16 that changes the angle of the tapes 53.

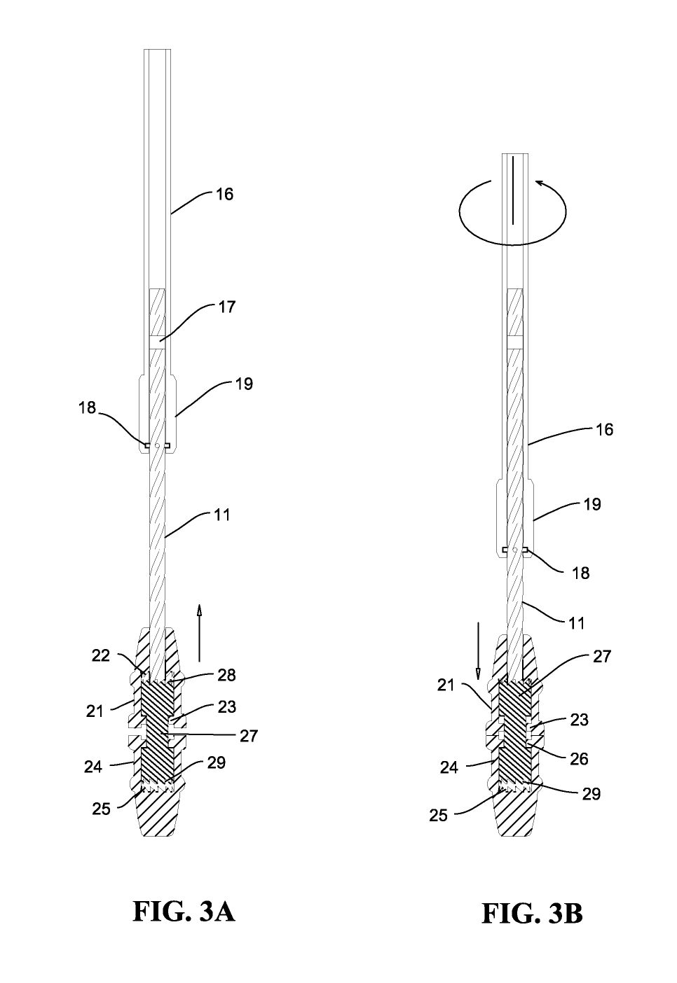

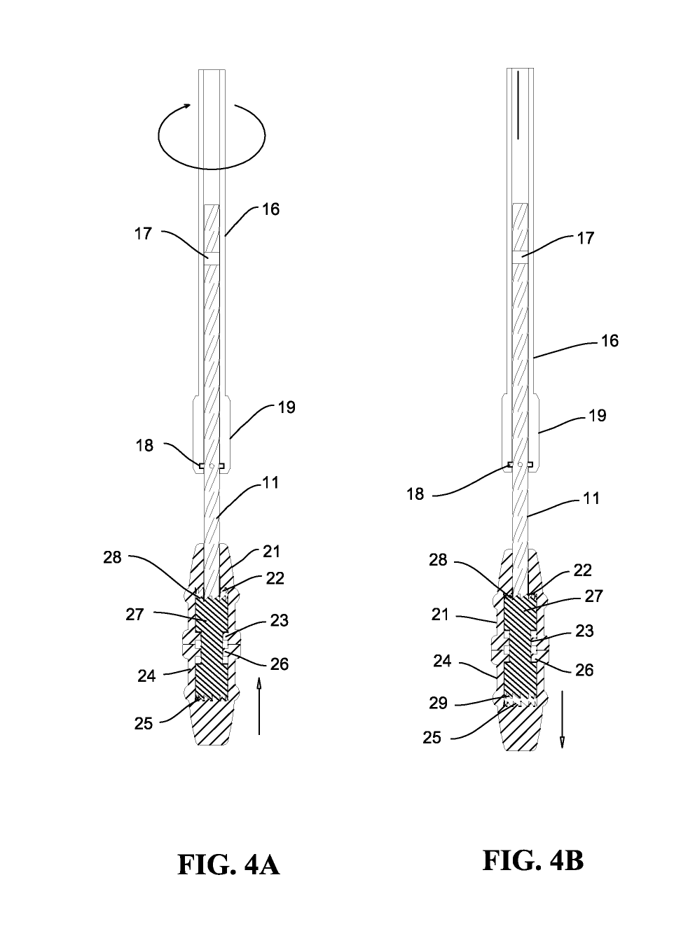

With reference to FIGS. 3A, 3B, 4A and 4B, illustrating the movement of the control assembly 20 for raising and lowering the tapes 53. As shown in FIGS. 3A and 3B, in an embodiment, the control assembly 20 comprises an actuator 27, an upper housing 21 and a lower housing 24. The actuator 27 has a recess 31, a first gearwheel 28 and a second gearwheel 29. The first gearwheel 28 and the second gearwheel 29 are mounted at two end of the actuator 27 respectively.

The upper housing 21 comprises an upper flange 23 and an upper teethed portion 22. The upper flange 23 is located inside the upper housing 21 corresponded to the first gearwheel 28 of the actuator 27. The lower housing 24 comprises a lower flange 26 and a lower teethed portion 25. The lower flange 26 is located inside the lower housing 24 corresponded to the second gearwheel 29. As shown in FIGS. 3A, 3B, 4A and 4B, the actuator 27 is located in a space formed by the upper housing 21 and the lower housing 24, which the space is adaptively for containing the actuator 27 to interact with the spiral plunger 11. The upper flange 23 of the upper housing 21 and the lower flange 26 of the lower housing 24 are wedged respectively to the recess of the actuator 27 which makes the control assembly 20 as a single component.

In operating the blind apparatus, as shown in FIG. 3A, firstly, when the upper housing 21 of the control assembly 20 is moved upwardly along the spiral plunger 11 (i.e. a person holds the upper housing 21), the recess 31 of the actuator 27 is pulled by the upper flange 23 of the upper housing 21, which makes the first gearwheel 28 unlock from the upper teethed portion 22. Simultaneously, the recess 31 of the actuator 27 pulls the lower flange 26 of the lower housing 24, which unlocks the second gearwheel 29 from the lower teethed portion 25. Since the first gearwheel 28 and the second gearwheel 29 are unlock, the spiral plunger 11 spins according to the guiding protrusion 18, and the tube 16 remains still.

After the upper housing 21 moved for a desired height, and the person holds the upper housing 21 downwardly along the spiral plunger 11, as shown in FIG. 3B, the first gearwheel 28 of the actuator 27 will lock with the upper teethed portion 22 of the upper housing. Because of the person holds the upper housing 21 while the moving the upper housing 21 downwardly, it makes the actuator 27 being held still (stop spinning) and makes the tube 16 spin as the guiding protrusion 18 in response to the spiral of the spiral plunger 11.

When the spiral plunger 11 spin, the spiral plunger 11 triggers the EG assembly 13 through the universal joint 12, and let the EG assembly 13 drives the rolling module 50 to raise and/or descend the tapes 53. In this embodiment, the tube 16 spins anti-clockwise for raising the tapes 53. In additional, by implementing same movement several times as above mentioned, it makes the tube 16 spinning continually in the anti-clockwise way to completely raise the tapes 53. In other words, the blind apparatus of the present invention has the ability to conform any height of the window as desire.

In another aspect, as shown in FIGS. 4A and 4B, when the lower housing 24 of the control assembly 20 move upwardly along the spiral plunger 11 (i.e. the person holds the lower housing 24), the lower teethed portion 25 of the lower housing 24 will directly locked to the second gearwheel 29 of the actuator 27. Because the lower housing 24 has been held by the person's hand, it limits the spinning of the actuator 27 and makes the tube 16 spin as the guiding protrusion 18 in response to the spiral of the spiral plunger 11. In this embodiment, the tube 16 spins anti-clockwise to descend the tapes 53. Further, as shown in FIG. 4B, when the lower housing 24 move downwardly along the spiral plunger 11, the lower teethed portion 25 of the lower housing 24 will unlock from the second gearwheel 29 of the actuator 27. Although the first gearwheel 28 of the actuator 27 remains lock to the upper teethed portion 22 of the upper housing 21, the lower housing 24 is held by the person's hand that provides external force that limits the spin of the lower housing 24. The spiral plunger 11 will spin with the upper housing 21 and the actuator 27 and the tube 16 remains still. Similarity, by implementing same movement several times as above mentioned, it makes the tube 16 spinning continually in the clockwise way to completely raise the tapes 53, and has the ability to conform any height of the window as desire.

However, it is noted that a person skilled in art will realize that clockwise or anti-clockwise for raising or lowering the tapes 53 can be mutually exchanged.

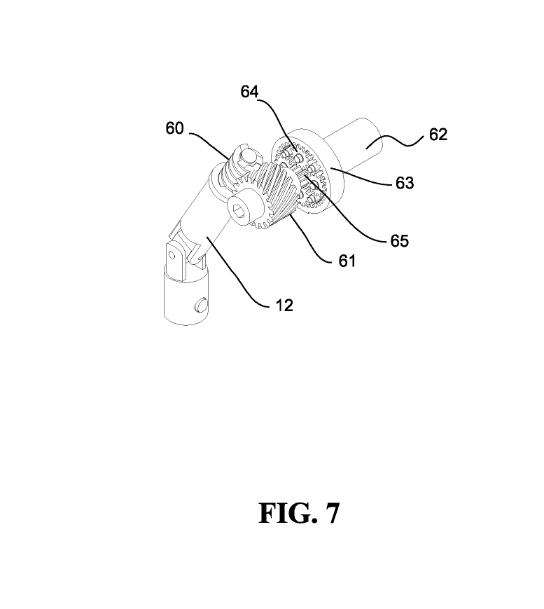

With reference to FIGS. 1, 5, 6A, 6B, 6C and 7, the rolling module 50 comprises a driving shaft 40, multiple lifting reels 41 and multiple flipping reels 42. Each lifting reel 41 has a shaft hole 44 and a lifting gearwheel 43. The shaft hole 44 of the lifting reel 41 is configured for inserting the driving shaft 40, and one of the lifting reel 41 is connected to the EG assembly 13, wherein the driving shaft 40 which are ganged up with the EG assembly 13 and the universal joint 12 when is triggered by the tube 16. The lifting gearwheels 43 of the lifting reels 41 are mounted corresponding to the eyelets of the tapes 53. The flipping reels 42 are engaged to the corresponding lifting reels 41, and having a top and an opening. The tops of the flipping reels 42 are configured for fixing the corresponding ladder cords 51 (i.e. through gluing or clipped). The opening comprises a teethed portion 45 and a smooth portion 46 formed at inner of the opening, which is corresponded to the lifting gearwheels 43 of the lifting reels 41 that is configured for engaging the teethed portion 45 with the lifting gearwheel 43.

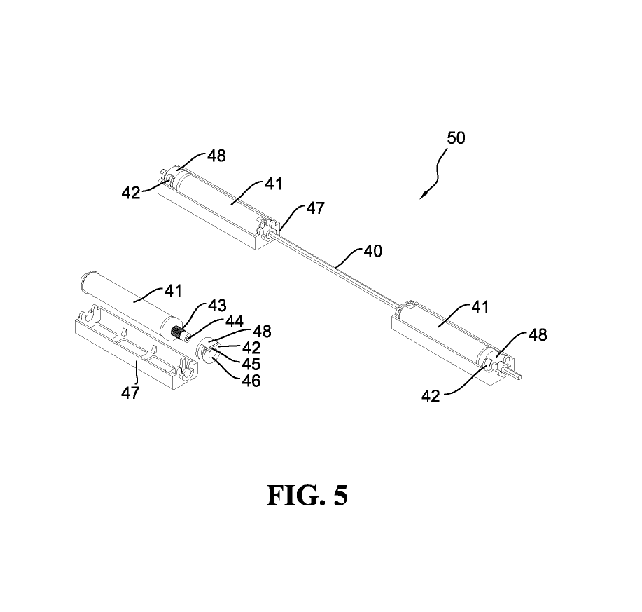

As shown in FIGS. 1 and 5, the lifting reel 41 of the rolling module 50 is in a cylinder shape and the shaft hole 44 is a polygonal hole. The driving shaft 40 is a polygonal stick that is corresponded to the shaft hole 44. The ratio of teethed portion 45 and a smooth portion 46 is 1:2, which formed a ⅓ teeth gear. Further, as shown in FIG. 5, there is a groove mounted at an outer of each flipping reels 42 which is configured for ganging the lifting reels 41 and the flipping reels 42 into a case 47.

The lifting cords 52 are twines round the corresponding lifting reels 41 and are extended downwardly from the rolling module 50 through the eyelets of the tapes 53, which allows the lifting reels 41 to raise and descend the tapes 53 using the lifting cords 52.

With reference to FIGS. 1, 2C and 7, the EG assembly 13 is a gear system comprises a screw 60, a turbine 61, a shaft 62, a ring gear 63, a planet gears 64 and a sun gear 65. The screw 60 is mounted at the opposite end where the universal joint 12 connects to the tube 16. The turbine 61 is orthogonally coupled to the screw 60. The planet gears 64 and the sun gear 65 are located inside the ring gear 63, which moves along the planet gears 64. The sun gear 65 is located at the center of the ring gear 63, and is connected to the turbine 61. The planet gears 64 are located around the sun gear 65. The shaft 62 is extended from ring gear 63 which opposites to the turbine 61, and connected to the driving shaft 40.

When tube 16 spins, the universal joint 12 drives the screw 60 interacting with the turbine 61 of the EG assembly 13 which triggers the planet gears 64 and the sun gear 65. The ring gear 63 and the shaft 62 then drive the driving shaft 40 to make the lifting reels 41 rotating for the lifting cords 53 to raise and descend the tapes 53.

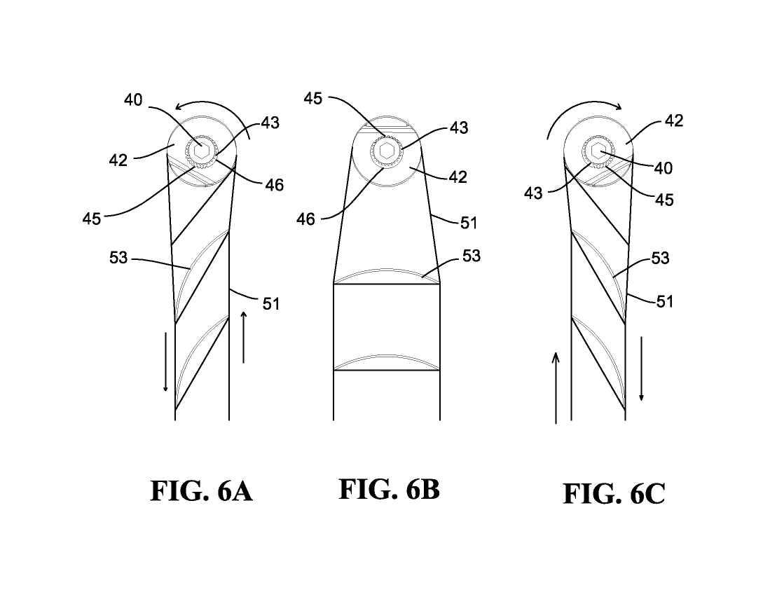

Moreover, in an similar manner, as the tilter 10 spin, the tilter 10 drives the tube 16 spin and makes the driving shaft 40 rotate by the EG assembly 13. The driving shaft 40 rotates the flipping reels 42 that pull the ladder cords 51 up and down to control the rotations of the tape 53. However, it is noted that, as shown in FIGS. 6B and 6C, although the spinning of the tube 16 that drives the flipping reels 42 may simultaneously drive the lifting reels 41 as well, the configuration of the teethed portion 45 and a smooth portion 46 will limit the spinning angle of the driving shaft 40. In other words, when the lifting gearwheels 43 of the lifting reels 41 spinning to the smooth portion 46 of the flipping reel 41, the driving shaft 40 will go self-spin and make the lifting reels 41 wound not rotate any further. Therefore, the lifting reels 41 remain fully function as purpose for lowering and raising the tapes 53 and are not affected by the flipping reels 42.

In other words, as the lifting reels 41 being ganged with the flipping reels 42, and the lifting reels 41 may rotate when operating the flipping reels 42. However, because of the smooth portion 46 and changing angle of the tapes 53 only require slightly rotation angle, the rotation of the tapes 53 will not take effect to the tapes 53 for lowering and raising.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus for a blind, comprising:
a rolling module being located above multiple tapes vertically spaced by a ladder cord, each tape has an eyelet that communicates to other eyelets and allows a lifting cord extended downwardly from the rolling module; and
a control module being extended downwardly from the rolling module, and comprising:
an Epicyclic Gearing (EG) assembly being connected to the rolling module;
a tube being a hollow column structure and having a guiding protrusion and a tilter, wherein the guiding protrusion is formed inside and bottom of the tube, and the tilter is formed outside of the tube corresponded to the guiding protrusion;
an universal joint being connected between the EG assembly and the tube, and being configured for connecting the rolling module;
a spiral plunger; and
a control assembly being penetrated through the spiral plunger, being located at bottom of the spiral plunger, and selectively moving up and down on the spiral plunger to rotate the tube, wherein the rolling module raises or lowers the tapes by the lifting cord according to the rotation of the tube.

2. The apparatus as claimed in claim 1, wherein the control assembly comprises
an actuator has a recess, a first gearwheel and a second gearwheel, wherein the first gearwheel and the second gearwheel are mounted at two end of the actuator respectively;
an upper housing comprises an upper teethed portion and an upper flange, the upper flange is located inside the upper housing corresponded to the first gearwheel of the actuator; and
a lower housing comprises a lower teethed portion and a lower flange, the lower flange is located inside the lower housing corresponded to the second gearwheel, wherein a space is formed by the upper housing and the lower housing, and is adaptively for containing the actuator to interact with the spiral plunger.

3. The apparatus as claimed in claim 2, wherein the recess of the actuator is pulled by the upper flange of the upper housing, which makes the first gearwheel being unlock from the upper teethed portion, and the second gearwheel being unlock from the lower teethed portion, the spiral plunger spins according to the guiding protrusion, and the tube remains still.

4. The apparatus as claimed in claim 3, wherein the first gearwheel of the actuator locked with the upper teethed portion of the upper housing, which makes the actuator being held still and makes the tube spin as the guiding protrusion in response to the spiral of the spiral plunger, and the spiral plunger through the EG assembly that drives the rolling module to raise or descend the tapes.

5. The apparatus as claimed in claim 2, wherein the lower teethed portion of the lower housing is locked to the second gearwheel of the actuator, which makes the tube spin as the guiding protrusion 18 in response to the spiral of the spiral plunger, and the spiral plunger through the EG assembly that drives the rolling module to raise or descend the tapes.

6. The apparatus as claimed in claim 5, wherein the lower teethed portion of the lower housing is unlock from the second gearwheel of the actuator, which makes the spiral plunger spinning with the upper housing and the actuator, and the tube remains still.

7. The apparatus as claimed in claim 1, wherein the rolling module comprises
a driving shaft;
multiple lifting reels, each lifting reel comprises
a shaft hole is configured for inserting the driving shaft; and
a lifting gearwheel is mounted on a side of the lifting reel; and
multiple flipping reels, are engaged to the corresponding lifting reels and each flipping reel has an opening, each opening comprises a teethed portion and a smooth portion formed at inner of the opening, which is corresponded to the lifting gearwheels of the lifting reels that is configured for engaging the teethed portion with the lifting gearwheel.

8. The apparatus as claimed in claim 7, wherein an ratio of teethed portion and a smooth portion is 1:2, which formed a ⅓ teeth gear.

9. The apparatus as claimed in claim 7, wherein the each flipping reel further comprises
a top, and the tops of the flipping reels are configured for fixing the corresponding ladder cords that controls the rotating angles of the tapes; and
a groove is mounted at an outer of each flipping reels which is configured for ganging the lifting reels and the flipping reels into a case.
